(19) United States
(12) Patent Application Publication
(10) Pub. No.: US 2025/0251774 A1
(43) Pub. Date: Aug. 7, 2025

(54) POWER CONSUMPTION MANAGEMENT OF A SOLID STATE DEVICE BASED ON OPERATION PRIORITY

(71) Applicant: Microchip Technology Incorporated, Chandler, AZ (US)

(72) Inventors: Nian Niles YANG, Mountain View, CA (US); Pitamber SHUKLA, San Jose, CA (US); Murthy HARI, San Jose, CA (US)

(21) Appl. No.: 18/977,506

(22) Filed: Dec. 11, 2024

Related U.S. Application Data
(60) Provisional application No. 63/550,600, filed on Feb. 6, 2024.

(51) Int. Cl. G06F 1/3234; G06F 1/329

(52) U.S. Cl. CPC G06F 1/3275; G06F 1/329

(57) ABSTRACT

In some implementations, a controller may initiate a first operation on a first die of a storage device. The controller may detect a request to perform a second operation on a second die of the storage device. The first die may be different than the second die. The controller may suspend the first operation based on detecting the request.

### RELATED APPLICATION

This application claims priority to U.S. Provisional Patent Application No. 63/550,600 entitled “POWER CONSUMPTION MANAGEMENT OF A SOLID STATE DEVICE BASED ON OPERATION PRIORITY,” filed Feb. 6, 2024, which is incorporated herein by reference in its entirety.

### FIELD

The present disclosure generally relates to power consumption of non-volatile memory devices and, for example, to power consumption management of non-volatile memory devices.

### BACKGROUND

A non-volatile memory device may include a memory device that may store and retain data without external power supply. One example of a non-volatile memory device is a NAND flash memory device. A solid-state drive (SSD) may include a controller and a plurality of non-volatile memory devices. The non-volatile memory devices may store data that is accessible via the controller. The controller may control operations performed on the SSD. The operations may include read operations, write operations, and erase operations.

### SUMMARY

A storage device may comprise: a first die; a second die; and a controller to: initiate a first operation on the first die of the storage device; detect a request to perform a second operation on the second die of the storage device, the first die being different than the second die; determine a power consumption of the storage device; determine a priority associated with the second operation; and suspend the first operation based on: detecting the request, he power consumption, and the priority.

A method may comprise initiating a first operation on a first die of a non-volatile memory device; detecting a request to perform a second operation on a second die of the non-volatile memory device, the first die being different than the second die; and suspending the first operation based on detecting the request.

A computer program product may comprise: one or more computer readable storage media, and program instructions collectively stored on the one or more computer readable storage media, the program instructions comprising: program instructions to initiate a first operation on a first die of a storage device; program instructions to detect a request to perform a second operation on a second die of the storage device, the first die being different than the second die; and program instructions to determine a power consumption of the storage device; and program instructions to suspend the first operation based on: the request, and the power consumption.

### BRIEF DESCRIPTION OF THE DRAWINGS

FIG. 1 is a diagram of an example implementation described herein.

FIG. 2 is a flowchart of an example process associated with managing power consumption based on priorities of operations performed on an SSD.

FIGS. 3-5 are flowcharts of example processes associated with power consumption management of a solid state device based on operation priority.

### DETAILED DESCRIPTION

The following detailed description of example implementations refers to the accompanying drawings. The same reference numbers in different drawings may identify the same or similar elements.

A controller of a solid state drive (SSD) may control operations performed on non-volatile memory devices of the SSD. The operations may include read operations, write operations, and erase operations. Performing the operations consumes power.

Currently, power consumption of an SSD is managed using an existing power token based power management technique. The power token based management technique may be used to determine if power is to be available for an upcoming operation while an ongoing operation is consuming the power until the ongoing operation is completed. The term “upcoming operation” may be used to refer to an operation that has been requested but has not been initiated. The term “ongoing operation” may be used to refer to an operation that is being performed. If the ongoing operation consumes power such that power allocated to the SSD is completely utilized, the upcoming operation may be prevented from being performed until the ongoing operation is completed.

Currently, the power token based management technique does not account for whether performing the upcoming operation is related to performance or quality of service (QOS) of the SSD. Accordingly, the power token based management technique may prevent the upcoming operation (related to performance or QoS) from being performed until the ongoing operation is completed. Preventing the upcoming operation may result in performance and QoS issues for the SSD. Accordingly, the power token based management technique may present a technical problem with respect to upcoming operations related to performance or QoS.

With respect to QoS, some approaches may attempt to speed up operations of numerous components of the SSD (e.g., application-specific integrated circuit (ASIC), non-volatile memory devices, static random-access memory (SRAM), double data rate (DDR), without limitation) to improve the QoS. However, such approaches are limited and are expensive and difficult to scale while the power consumption may be uncertain, because the QoS requirements will be more stringent.

Implementations described herein provide a technical solution to the technical problem discussed above. For example, implementations described herein are directed to determining a priority of a second operation to be performed (e.g., an upcoming operation) and suspending a first operation (e.g., an ongoing operation) based on the priority of the second operation. For instance, a controller may receive a request for the second operation to be performed.

The first operation and the second operation may be performed on different dies. In some examples, the different dies may be included on a same non-volatile memory device. Alternatively, the different dies may be included on different non-volatile memory devices. In other words, the controller may consider the power consumption on an entirety of the SSD.

The controller may determine that a current power consumption of the SSD prevents the second operation from being performed with the first operation. For example, the controller may determine that a power budget of the SSD has been met. “Power budget,” as used herein, may refer to power allocated to operations performed on the SSD. In this regard, the controller may determine that the power allocated to operations of the SSD has been met.

Based on determining that a current power consumption of the SSD prevents the second operation from being performed with the first operation, the controller may determine a second priority of the second operation and determine whether the second priority exceeds a first priority of the first operation. Based on determining that the second priority exceeds the first priority, the controller may initiate a suspend operation to suspend the first operation.

Suspending the first operation may reduce the power consumption of the SSD such that the second operation may be performed. Based on suspending the first operation and based on determining that the power consumption such that the second operation may be performed, the controller may initiate the second operation. In some situations, the controller may suspend multiple operations (including the first operation) on multiple dies. The controller may initiate a resume operation to resume the first operation after the second operation is completed.

By suspending the first operation (or suspending the multiple operations on the multiple dies) and initiating the second operation, the controller may ensure that the second operation (with the second priority exceeding the first priority is performed) is performed without delays. In other words, by suspending and initiating operations based on priorities and power consumption, the controller may prevent performance and QoS issues of the SSD. Implementations described herein may suspend ongoing operations on the SSD to ensure that an upcoming operation (with a priority exceed priorities of the ongoing operations) is performed, thereby preserving or even improving performance and QoS of the SSD.

In some cases, a priority associated with a read operation may exceed priorities of other operations. In other cases, a priority of an upcoming operation (other than a read operation) may exceed priorities of ongoing operations. In this regard, if the power provided to the SSD is not sufficient to enable the ongoing operations and the upcoming operation to be performed, the ongoing operations may be suspended to enable the upcoming operation to be performed. In some situations, the ongoing operations may be suspended multiple times to enable multiple upcoming operations to be performed.

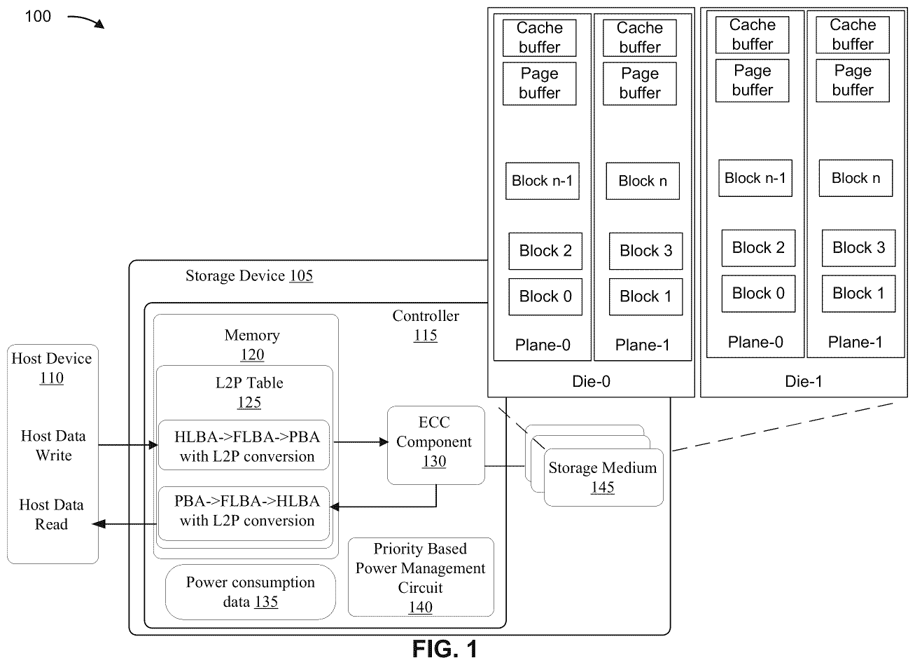

FIG. 1 is a diagram of an example implementation 100 described herein. Example implementation 100 describes components and operations associated with a storage device 105. In some implementations, storage device 105 may include a solid state drive (SSD). As shown in FIG. 1, storage device 105 may be associated with a host device 110. Host device 110 may read data (also referred to as “host data”) stored by storage device 105, may write data to storage device 105, or a combination of the foregoing. For example, as shown in FIG. 1, host device 110 may initiate a host data write operation (e.g., a write operation) to write the host data to storage device 105 (e.g., to store the data on storage device 105) and may initiate a host read operation (e.g., a read operation) to read the host data from storage device 105.

Host device 110 may include one or more devices capable of receiving, generating, storing, processing, and/or providing information associated with generating an L2P data structure (or L2P table), as described elsewhere herein. The host device 110 may include a communication device and a computing device. For example, the host device 110 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

As shown in FIG. 1, storage device 105 may include a controller 115. Controller 115 may include one or more of an application specific integrated circuit (ASIC) or firmware. Controller 115 may cause functions to be performed on storage device 105, such as read operations, write operations, erase operations, and garbage collection operations, among other examples. Controller 115 may include a memory 120 and an error correction code (ECC) component 130. Memory 120 may include a RAM (e.g., dynamic random access memory (DRAM) and a synchronous DRAM (SDRAM), among other examples).

As shown in FIG. 1, memory 120 may include an L2P table 125 (or an L2P data structure). L2P table 125 may store a mapping between host logical block addresses (or logical addresses identified by host device 110) and physical block addresses (or physical addresses of non-volatile memory devices of storage device 105). In some implementations, L2P table 125 may be generated by controller 115.

In some implementations, controller 115 may identify a host logical block address (HLBA) associated with the host data by which host device 110 may reference the host data in a future read operation. As shown in FIG. 1, controller 115 may convert the HLBA to a flash logical block address (FLBA) or other local logical block address, and then may link the FLBA to a physical block address (PBA) using an L2P conversion process. Conversely, controller 115 may convert a PBA to an FLBA or other local logical block address, and then may link the FLBA to a HLBA using a physical to logical conversion process. In this way, the host device may send a static address associated with the host data, controller 115 may link the address known to host device 110 to an address known to storage device 105 (the FLBA), and may link the address known to storage device 105 to a physical address of the host data within a storage medium of storage device 105.

Controller 115 may store the links between the HLBA, the FLBA, and the PBA in L2P table 125. In some aspects, the host data may be moved within the storage medium or between storage mediums of storage device 105, which controller 115 may note in the link between the FLBA and the physical location. In this way, the HLBA may bypass being updated when the host data is moved to a new PBA.

ECC component 130 may include an ECC engine. ECC component 130 may perform error correction code encoding on the host data. In some implementations, the error correction code encoding may include adding redundancy, parity bits, or other information that can later be used to identify errors in the host data when read from the storage medium. Controller 115 may provide the host data, after encoding, via flash control channels (not shown) to write on storage mediums of storage device 105. In some implementations, ECC component 130 may perform decoding on data obtained from storage device 105.

As shown in FIG. 1, controller 115 may include power consumption data 135. Power consumption data 135 may be stored in a memory of controller 115, such as memory 120, another memory, or a combination of the foregoing. In some implementations, power consumption data 135 may be stored in a memory external to controller 115. Power consumption data 135 may include information regarding power consumption by different operations performed by different components of storage device 105. In some implementations, power consumption data 135 may include information regarding an amount of power consumed by different operations (e.g., erase operations, read operations, write operations, and garbage collection operations, without limitation).

In some implementations, power consumption data 135 may include information regarding an amount of power consumed by different portions of an operation (e.g., a beginning of the operation and an ending of the operation, without limitation). In some implementations, power consumption data 135 may include information regarding an amount of power consumed by different dies (e.g., 128 dies), an amount of power consumed by power consumption by one or more DRAMs, and an amount of power consumed by power consumption by one or more static RAMs, without limitation. In some implementations, power consumption data 135 may be used to determine an amount of power consumed by an operation based on the operation, based on a die on which the operation is to be performed, based on a storage medium on which the operation is performed, or a combination of the foregoing.

As shown in FIG. 1, controller 115 may include a priority based power management circuit 140 (also referred to as “power management circuit 140”). Power management circuit 140 may manage power consumed by storage device 105 by suspending and resuming operations performed on storage device 105. As described herein, power management circuit 140 may determine, using power consumption data 135, power consumed by one or more ongoing operations, determine priorities associated with the one or more ongoing operations and an upcoming operation, and suspend the one or more ongoing operations to initiate the upcoming operation based on the power consumed and the priorities.

As shown in FIG. 1, storage device 105 may include storage mediums 145 (individually “storage medium 145” and collectively “storage mediums 145”). A storage medium 145 may include a non-volatile memory device. For example, the storage medium 145 may include a NAND memory device. In some situations, storage mediums 145 may be organized by data pools. A “data pool” may be used to refer to part of a storage medium 145 that stores a given type of data (e.g., single-layer cell (SLC) data, multi-layer cell (MLC) data, and triple-layer cell (TLC) data, without limitation).

As shown in FIG. 1, a storage medium 145 may include multiple dies. In some implementations, a die may include multiple planes. A plane may include multiple memory blocks (also referred to as “block”), one or more page buffers (associated with the blocks), and one or more cache buffers.

As indicated above, FIG. 1 is provided as an example. Other examples may differ from what is described with regard to FIG. 1. The number and arrangement of devices shown in FIG. 1 is provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

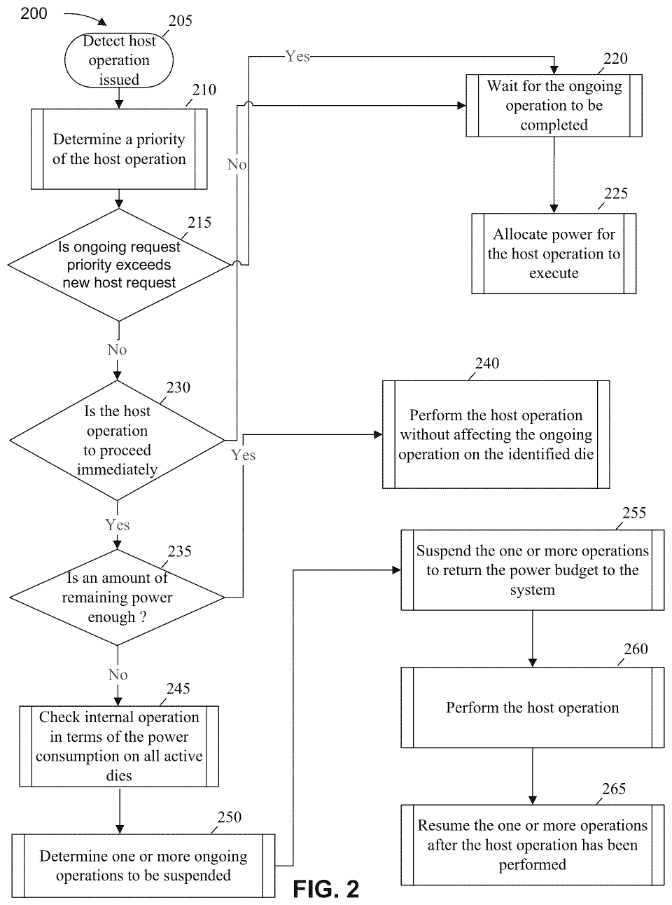

FIG. 2 is a flowchart of an example process 200 associated with power consumption management based on priorities of upcoming operations. In some implementations, one or more process blocks of FIG. 2 may be performed by a controller (e.g., controller 115). In some implementations, one or more process blocks of FIG. 2 may be performed by another device or a group of devices separate from or including the controller, such as a power management circuit (e.g., power management circuit 140).

As shown in FIG. 2, process 200 may include detecting that a host operation has been issued (block 205). The “host operation” may refer to an operation initiated by host device 210. For example, controller 115 may detect that host device 110 has issued a command to perform an operation. As explained herein, the host operation may be an upcoming operation.

As an example, the host operation may include a write operation to store (on storage device 105) data obtained by host device 110 (e.g., to store a picture captured by host device 110). As another example, the host operation may include a read operation to retrieve (from storage device 105) data obtained by host device 110 (e.g., to retrieve a picture captured by host device 110 and stored on storage device 105). The data may be stored on or retrieved from a die of storage device 105. For example, the die may be included on storage medium 145 of storage device 105. The die may be identified by the command. In some implementations, priorities of read operations and write operations (e.g., initiated by host device 110) may exceed priorities of other operations performed on storage device 105.

As shown in FIG. 2, process 200 may include determining a priority of the host operation (block 210). For example, after detecting that host device 110 has issued the command, controller 115 may determine a priority of the host operation. In some implementations, the command may include information identifying the priority of the host operation. For instance, the command may indicate that the host operation is to be performed immediately.

As shown in FIG. 2, process 200 may include determining whether ongoing request priority exceeds new host request (block 215). For example, controller 115 may determine other priorities of ongoing operations being performed on storage device 105. The ongoing operations may be operations being performed on other dies of storage device 105. In some examples, the other dies may include a die of another storage medium 145. Alternatively, the other dies may include another die of a same storage medium 145 (e.g., the same storage medium 145 on which the host operation is to be performed). Controller 115 may determine whether the other priorities (of the ongoing operations) exceed the priority (of the host operation).

As shown in FIG. 2, process 200 may include waiting for the ongoing operation to be completed, if other priorities exceeds the priority (block 220). For example, controller 115 may determine that the other priorities exceed the priority. For instance, if the ongoing operations include read operations or write operations initiated by host device 110, controller 115 may determine that the other priorities exceed the priority. Based on determining that the other priorities exceed the priority, controller 115 may wait for the ongoing operation to be completed prior to performing the host operation.

As shown in FIG. 2, process 200 may include allocating power for the host operation to execute (block 225). For example, after the ongoing operations are completed, controller 115 may allocate power for the host operation to be performed. In other words, controller 115 may reserve the power (released after the ongoing operations have been completed) for execution of the host operation. By allocating (or reserving) the power, controller 115 may ensure that other ongoing operations that are not completed and still running or other incoming operations do not utilize the power released. For instance, controller 115 may allocate a power budget for the host operation to be performed. Controller 115 may suspend some ongoing operations in order to make power available for a more critical operation.

In some implementations, controller 115 may suspend one or more of the ongoing operations that are not completed and still running to ensure that sufficient power is allocated for the host operation. In some implementations, controller 115 may prevent one or more incoming operations from being performed to ensure that sufficient power is allocated for the host operation.

As shown in FIG. 2, process 200 may include determining whether the host operation is to proceed immediately (block 230). For example, after determining that the other priorities (of the ongoing operations) do not exceed the priority (of the host operation), controller 115 may determine whether the host operation is to proceed immediately. For instance, controller 115 may determine that the ongoing operation includes erase operations (initiated by host device 110 or initiated independent of host device 110, initiated as part of garbage collection operations, initiated as part of operations associated with telemetry, initiated as part of status read operations). The operations associated with telemetry may refer to host device 105 inquiring about a status of storage device 105 (e.g., with respect to health monitoring or performance metrics, without limitation). The status read operations may refer to controller 115 inquiring about a status of a die of storage device 105 (e.g., whether the die is available for a read operation, a write operation, or an erase operation, without limitation). Accordingly, controller 115 may determine that the priority of the host operation exceeds the other priorities of the ongoing operations. Therefore, controller 115 may determine that the host operation is to be performed prior to completion of the ongoing operations.

In some implementations, after determining that the host operation is to be performed prior to completion of the ongoing operations, controller 115 may determine whether the host operation is to proceed immediately. For example, the host operation may be an operation that is to proceed immediately if the host operation is associated with a latency goal (e.g., latency sensitivity). For instance, the host operation may be a read operation which is associated with a latency goal as opposed to an erase operation which is an operation that is not associated with a latency goal. If the priority of the host operation exceeds the priority of the ongoing operations, the host operation may proceed and the ongoing operations may be suspended. In some situations, if the priority of the host operation exceeds the priority of the ongoing operations, the ongoing operations may proceed if the ongoing operations are internal read operations that are not initiated by host device 110.

As shown in FIG. 2, process 200 may include determining whether an amount of remaining power is enough to enable the host operation to be performed (block 235). For example, controller 115 may determine that the host operation is to proceed immediately. Based on determining that that the host operation is to proceed immediately, controller 115 may determine whether a total amount of power remaining for storage device 105 (e.g., remaining in light of an amount of power used by one or more ongoing operations) is sufficient to enable the host operation to be performed.

In some implementations, controller 115 (e.g., power management circuit 140) may determine the amount of power remaining based on power consumption data 135. In some situations, controller 115 may obtain power consumption data 135 from memory 120 and perform calculations to determine the amount of power remaining. In some situations, controller 115 may obtain power consumption data 135 from memory 120 and perform calculations to determine an amount of power consumed by different dies of storage device 105.

In some examples, the power consumption data 135 may include information regarding an average power consumption of different dies of different storage mediums 145, information regarding a peak power consumption of different dies of different storage mediums 145, information regarding an amount of power consumed during data transfer into different dies of different storage mediums 145, information regarding an amount of power consumed during data transfer into different dies of different storage mediums 145, information regarding an amount of power consumed during data transfer from different dies of different storage mediums 145, information regarding an amount of power consumed during write operations (or data programming operations), information regarding an amount of power consumed during block erase operations, information regarding an amount of power consumed during block erase operations, and information regarding an amount of power consumed during sensing operations, without limitation. Power consumption data 135 may include information regarding an amount of power consumed by individual dies of storage device 105.

Controller 115 may identify ongoing operations being performed on different dies of storage devices and determine an amount of power consumed by individual ongoing operation using power consumption data 135. Controller 115 may determine a total amount of power consumed by the ongoing operations by, for example, adding the amount of power consumed by individual ongoing operation.

Power consumption data 135 may store information identifying a total amount of power allocated for storage device 105. The total amount of power allocated may be referred to as a power budget. Controller 115 may determine the total amount of remaining power based on the total amount of power allocated and the total amount of power consumed by the ongoing operations. For example, controller 115 may determine the total amount of remaining power by subtracting the total amount of power allocated and the total amount of power consumed by the ongoing operations the total amount of remaining power.

Controller 115 may determine an amount of power to be consumed by the host operation using power consumption data 135. For example, as explained herein, power consumption data 135 may include information regarding an amount of power consumed during different operations performed on different storage mediums 145. In some implementations, power consumption data 135 may include information identifying an amount of power consumed by each operation on each of storage medium 145. For example, power consumption data 135 may include information identifying a predefined amount of power consumption for each different operation and storage medium combination. For example, power consumption data 135 may include information identifying a first amount of power consumption for a read operation on a first storage medium 145, a second amount of power consumption for a read operation on a second storage medium 145, and so on for additional storage mediums 145, a third amount of power consumption for a write operation on the first storage medium 145, a fourth amount of power consumption for a write operation on the second storage medium 145, and so on, a fifth amount of power consumption for an erase operation on the first storage medium 145, a sixth amount of power consumption for an erase operation on the second storage medium 145, and so on. In some implementations, power consumption data 135 may include information identifying a predefined amount of power consumption for each operation irrespective of a storage medium 145 on which the operation is performed. In some situations, power consumption data 135 may be based on specifications of storage mediums 145. In some implementations, controller 115 may determine the operation to be performed by the host operation and a storage medium 145 on which the host operation is to be performed. Based on determining the operation to be performed by the host operation and determining the storage medium 145, controller 115 may use power consumption data 135 to determine the amount of power consumed during the operation on the storage medium 145. Controller 115 may determine whether the total amount of remaining power exceeds the amount of power to be consumed by the host operation. One example is that if controller 115 knows that the host will program a storage medium, the power for the NAND programming, which is individually known from the technology characterization, controller 115 may compute how much total power is needed for the amount of writing data (aka the number of NAND dies to be all programmed).

As shown in FIG. 2, process 200 may include performing the host operation without affecting an ongoing operation on the targeted die (block 240). For example, controller 115 may determine that the total amount of remaining power exceeds the amount of power to be consumed by the host operation. Based on determining that the total amount of remaining power exceeds the amount of power to be consumed by the host operation, controller 115 may cause the host operation to be performed. Because the total amount of remaining power exceeds the amount of power to be consumed by the host operation, performing the host operation may not affect ongoing operations on storage device 105.

As shown in FIG. 2, process 200 may include checking internal operations in terms of the power consumption on all active dies (block 245). For example, controller 115 may determine an amount of power being consumed by the internal operations. The internal operations, as used herein, may be part of a management algorithm of the storage medium, a wear leveling of the storage medium, and a garbage collection (which involves block data refresh). Block data refresh may refer to reading the data from a first block experiencing read errors (as detected using an error correction code algorithm) and writing the data to a second block to improve the reliability of the data. An erase operation may be performed on the first block after a host provides a request to delete data. The erase operation may be performed as a background process to improve the performance of storage device 105. The internal operations may be initiated by the firmware of storage device 105, without instructions from host device 110. The internal operations are usually used by storage device 105 for scan reads to determine the read quality or for garbage collection to free up unused space on storage device 105. The internal operations may consume different amounts of power. The internal operations may include a program operation, a read operation, and an erase operation, without limitation. In some situations, the amount of power consumed by the internal operations may be pre-determined (e.g., at time of manufacture of storage device 105). Accordingly, based on identifying the internal operations, controller 115 may determine a total power consumption of storage device 105 as a result of the internal operation being performed. For example, controller 115 may determine that the amount of power to be consumed by the host operation exceeds the total amount of remaining power. Based on determining that the amount of power to be consumed by the host operation exceeds the total amount of remaining power, controller 115 may determine that one or more ongoing operations on storage device 105 are to be suspended. In this regard, controller 115 may identify ongoing operations on different dies and may determine, using power communication data 135, power consumed by the ongoing operations. Controller 115 may identify one or more ongoing operations, of the ongoing operations, to be suspended (block 250). For example, controller 115 may determine an amount of power consumed by different dies of storage device 105 based on the amount of power consumed by the ongoing operations. Controller 115 may determine one or more dies that consume an amount of power that satisfies a power threshold based on the amount of power consumed by the one or more ongoing operations on the one or more dies. In some implementations, the power threshold may be a predefined threshold. In some implementations, the power threshold may be based on historical power consumption on the one or more dies (e.g., power consumption by operations similar to the one or more ongoing operations). Based on determining that the one or more dies consume an amount of power that satisfies the power threshold, controller 115 may send a command to suspend the one or more ongoing operations.

As shown in FIG. 2, process 200 may include suspending the one or more operations to return the power budget to the system (block 255). For example, after identifying the one or more operations, controller 115 may suspend the one or more operations. By suspending the one or more operations, controller 115 may cause the power used by the one or more operations to be allocated for performing the host operation. In some implementations, an entirety of the power budget may be returned to the system. In some implementations, a portion of the power budget may be returned to the system.

As shown in FIG. 2, process 200 may include performing the host operation (block 260). For example, after suspending the one or more operations, controller 115 may perform the host operation using the power allocated for performing the host operation.

As shown in FIG. 2, process 200 may include resuming the one or more operations after the host operation has been performed (block 265). For example, after performing the host operation, controller 115 may resume the one or more operations.

Although FIG. 2 shows example blocks of process 200, in some implementations, process 200 may include additional blocks, fewer blocks, different blocks, or differently arranged blocks than those depicted in FIG. 2. Additionally, or alternatively, two or more of the blocks of process 200 may be performed in parallel.

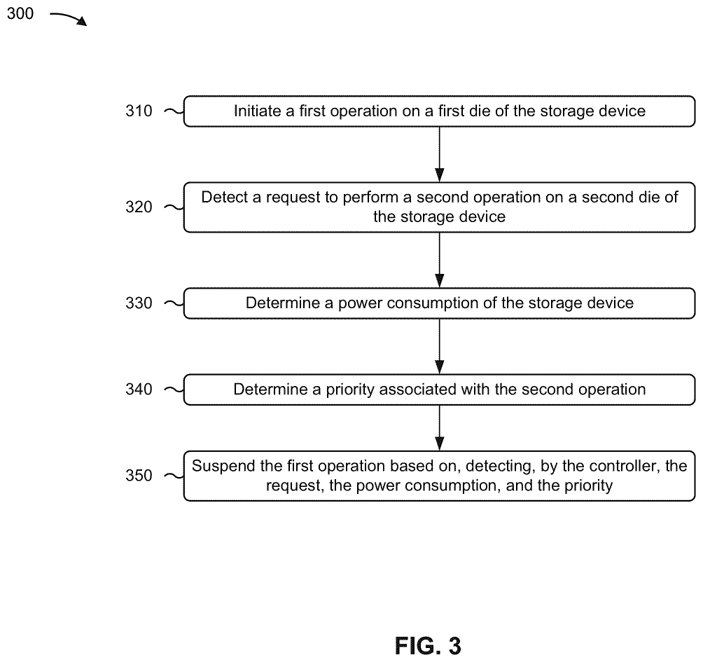

FIG. 3 is a flowchart of an example process 300 associated with power consumption management of a solid state device based on operation priority, as described herein. In some implementations, one or more process blocks of FIG. 3 may be performed by a storage device (e.g., storage device 105). In some implementations, one or more process blocks of FIG. 3 may be performed by another device or a group of devices separate from or including the storage device, such as a power management circuit (e.g., power management circuit 140).

As shown in FIG. 3, process 300 may include initiating a first operation on a first die of the storage device (block 310). For example, the first operation may be part of ongoing operations being performed on storage device 105, as described in block 215. The ongoing operations may be operations being performed on a die of storage device 105, as described in block 215.

As further shown in FIG. 3, process 300 may include detecting a request to perform a second operation on a second die of the storage device, the first die being different than the second die (block 320). For example, the second operation may be initiated by host device 110, as described above in connection with block 205. In some examples, controller 115 may detect that host device 110 has issued a command to perform the second operation. As explained herein in connection with block 205, the second operation may be an upcoming operation.

As further shown in FIG. 3, process 300 may include determining a power consumption of the storage device (block 330). For example, the storage device (e.g., controller 115) may may obtain power consumption data 135 from memory 120 and perform calculations to determine an amount of power consumed by different dies of storage device 105, as described in connection with block 235.

As further shown in FIG. 3, process 300 may include determining a priority associated with the second operation (block 340). For example, the storage device (e.g., controller 115) may determine a priority associated with the second operation, as described above in connection with block 210.

As further shown in FIG. 3, process 300 may include suspending the first operation based on: detecting the request, the power consumption, and the priority (block 350). For example, the storage device (e.g., controller 115) may suspend the one or more operations, as described in connection with block 255. By suspending the one or more operations, controller 115 may cause the power used by the one or more operations to be allocated for performing the second operation.

In some implementations, the first die is included on a first storage medium, and wherein the second die is included on a second storage medium.

In some implementations, the controller is to initiate the second operation on the second die after suspending the first operation, completing the second operation on the second die, and resuming the first operation on the first die after completing the second operation on the second die.

In some implementations, process 300 includes determining that the power consumption of the storage device prevents the second operation from being performed with the first operation and a third operation on a third die, and suspending the first operation and the third operation based on detecting the request, determining that the power consumption of the storage device prevents the second operation from being performed with the first operation and the third operation, and the priority.

In some implementations, the priority is a first priority, and wherein, to suspend the first operation, the controller is to determining that the first priority exceeds a second priority associated with the first operation, and suspending the first operation based on detecting the request, determining that the power consumption of the storage device prevents the second operation from being performed with the first operation, and determining that that the first priority exceeds the second priority.

In some implementations, the controller is to determine that sufficient power has been allocated to perform the second operation after suspending the first operation, and initiating the second operation on the second storage medium based on determining that sufficient power has been allocated to perform the second operation.

In some implementations, process 300 includes receiving the request from a host computing device associated with the storage device.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

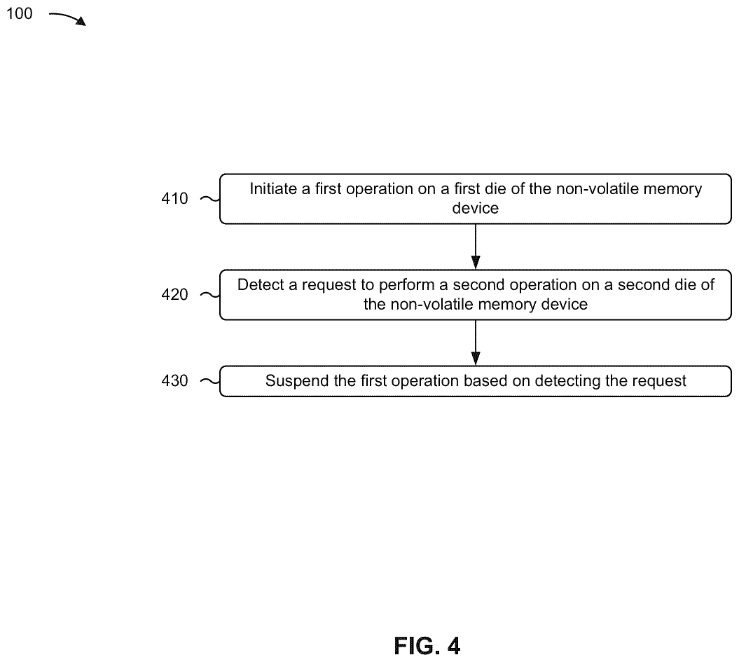

FIG. 4 is a flowchart of an example process 400 associated with power consumption management of a solid state device based on operation priority, as described herein. In some implementations, one or more process blocks of FIG. 4 may be performed by a controller (e.g., controller 115). In some implementations, one or more process blocks of FIG. 4 may be performed by another device or a group of devices separate from or including the storage device, such as a power management circuit (e.g., power management circuit 140).

As shown in FIG. 4, process 400 may include initiating a first operation on a first die of the non-volatile memory device (block 410). For example, the first operation may be part of ongoing operations being performed on storage device 105, as described in block 215. The ongoing operations may be operations being performed on a die of storage device 105, as described in block 215. the controller may initiate a first operation on a first die of the non-volatile memory device, as described above.

As further shown in FIG. 4, process 400 may include detecting a request to perform a second operation on a second die of the non-volatile memory device, the first die being different than the second die (block 420). For example, the second operation may be initiated by host device 110, as described above in connection with block 205. In some examples, controller 115 may detect that host device 110 has issued a command to perform the second operation. As explained herein in connection with block 205, the second operation may be an upcoming operation.

As further shown in FIG. 4, process 400 may include suspending the first operation based on detecting the request (block 430). For example, the controller may suspend the one or more operations, as described in connection with block 255. By suspending the one or more operations, controller 115 may cause the power used by the one or more operations to be allocated for performing the second operation.

In some implementations, suspending the first operation comprises suspending the first operation based on detecting the request and based on a power limitation of the non-volatile memory device.

In some implementations, suspending the first operation comprises suspending the first operation based on detecting the request and based on a power allocated to operations performed on the non-volatile memory device.

In some implementations, suspending the first operation comprises determining that the power does not support the first operation being performed along with the second operation, and suspending the first operation based on determining that the power does not support the first operation being performed along with the second operation.

In some implementations, process 400 includes determining that sufficient power has been allocated to perform the second operation after suspending the first operation, and initiating the second operation on the second die based on determining that sufficient power has been allocated to perform the second operation.

In some implementations, process 400 includes initiating the second operation on the second die after suspending the first operation, completing the second operation on the second die, and resuming the first operation on the first die after completing the second operation on the second die.

In some implementations, the first operation comprises a first read operation, a first write operation, or a first write operation, and wherein the second operation comprises a second read operation, a second write operation, or a second write operation.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

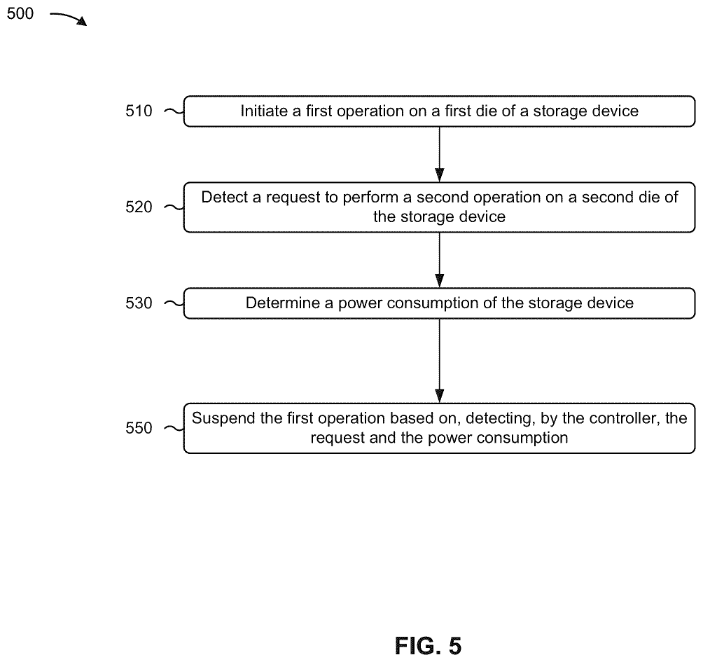

FIG. 5 is a flowchart of an example process 500 associated with power consumption management of a solid state device based on operation priority, as described herein. In some implementations, one or more process blocks of FIG. 5 may be performed by a storage device (e.g., storage device 105). In some implementations, one or more process blocks of FIG. 5 may be performed by another device or a group of devices separate from or including the storage device, such as a power management circuit (e.g., power management circuit 140).

As shown in FIG. 5, process 500 may include program instructions to initiate a first operation on a first die of a storage device (block 510). For example, the first operation may be part of ongoing operations being performed on storage device 105, as described in block 215. The ongoing operations may be operations being performed on a die of storage device 105, as described in block 215.

As further shown in FIG. 5, process 500 may include program instructions to detect a request to perform a second operation on a second die of the storage device, the first die being different than the second die (block 520). For example, the second operation may be initiated by host device 110, as described above in connection with block 205. In some examples, controller 115 may detect that host device 110 has issued a command to perform the second operation. As explained herein in connection with block 205, the second operation may be an upcoming operation.

As further shown in FIG. 5, process 500 may include program instructions to determine a power consumption of the storage device (block 530). For example, the controller may program instructions to determine a power consumption of the storage device, as described above in connection with block 235.

As further shown in FIG. 5, process 500 may include programming instructions to suspend the first operation based on: the request, and the power consumption (block 540). For example, the controller may program instructions to suspend the one or more operations, as described in connection with block 255. By suspending the one or more operations, controller 115 may cause the power used by the one or more operations to be allocated for performing the second operation.

In some implementations, the program instructions to detect the request comprise programming instructions to receive the request from a host computing device associated with the storage device.

In some implementations, the program instructions comprise program instructions to initiate the second operation on the second die after suspending the first operation, programming instructions to complete the second operation on the second die, and program instructions to resume the first operation on the first die after completing the second operation on the second die.

In some implementations, the first die and the second die are included on a storage medium of the storage device.

In some implementations, the program instructions comprise program instructions to determine that the power consumption of the storage device prevents the second operation from being performed with the first operation, and programming instructions to suspend the first operation based on detecting the request, and determining that the power consumption of the storage device prevents the second operation from being performed with the first operation.

In some implementations, the first operation comprises a first read operation, a first write operation, or a first write operation, and wherein the second operation comprises a second read operation, a second write operation, or a second write operation.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A storage device comprising:
a first die;
a second die; and
a controller to:
initiate a first operation on the first die of the storage device;
detect a request to perform a second operation on the second die of the storage device,
the first die being different than the second die;
determine a power consumption of the storage device;
determine a priority associated with the second operation; and
suspend the first operation based on:
detecting the request,
the power consumption, and
the priority.

2. The storage device of claim 1, wherein the first die is included on a first storage medium, and
wherein the second die is included on a second storage medium.

3. The storage device of claim 1, wherein the controller is to:
initiate the second operation on the second die after suspending the first operation;
complete the second operation on the second die; and
resume the first operation on the first die after completing the second operation on the second die.

4. The storage device of claim 1, wherein, to suspend the first operation, the controller is to:
determine that the power consumption of the storage device prevents the second operation from being performed with the first operation; and
suspend the first operation based on:
detecting the request,
determining that the power consumption of the storage device prevents the second operation from being performed with the first operation and the third operation, and
the priority.

5. The storage device of claim 1, wherein the priority is a first priority, and wherein, to suspend the first operation, the controller is to:
determine that the first priority exceeds a second priority associated with the first operation; and
suspend the first operation based on:
detecting the request,
determining that the power consumption of the storage device prevents the second operation from being performed with the first operation, and
determining that that the first priority exceeds the second priority.

6. The storage device of claim 1, wherein the controller is to:
determine that sufficient power has been allocated to perform the second operation after suspending the first operation; and
initiate the second operation on the second die based on determining that sufficient power has been allocated to perform the second operation.

7. The storage device of claim 1, wherein, to detect the request, the controller is to:
receive the request from a host computing device associated with the storage device.

8. A method comprising:
initiating a first operation on a first die of a non-volatile memory device;
detecting a request to perform a second operation on a second die of the non-volatile memory device,
the first die being different than the second die; and
suspending the first operation based on detecting the request.

9. The method of claim 8, wherein suspending the first operation comprises:
suspending the first operation based on detecting the request and based on a power limitation of the non-volatile memory device.

10. The method of claim 8, wherein suspending the first operation comprises:
suspending the first operation based on detecting the request and based on a power allocated to operations performed on the non-volatile memory device.

11. The method of claim 8, wherein suspending the first operation comprises:
determining that power allocated to operations performed on the non-volatile memory device does not support the first operation being performed along with the second operation; and
suspending the first operation based on determining that the power does not support the first operation being performed along with the second operation.

12. The method of claim 8, comprising:
determining that sufficient power has been allocated to perform the second operation after suspending the first operation; and
initiating the second operation on the second die based on determining that sufficient power has been allocated to perform the second operation.

13. The method of claim 8, comprising:
initiating the second operation on the second die after suspending the first operation;
completing the second operation on the second die; and
resuming the first operation on the first die after completing the second operation on the second die.

14. The method of claim 8, wherein the first operation comprises a first read operation, a first write operation, or a first write operation, and
wherein the second operation comprises a second read operation, a second write operation, or a second write operation.

15. A computer program product comprising:
one or more computer readable storage media, and program instructions collectively stored on the one or more computer readable storage media, the program instructions comprising:
program instructions to initiate a first operation on a first die of a storage device;
program instructions to detect a request to perform a second operation on a second die of the storage device,
the first die being different than the second die; and
program instructions to determine a power consumption of the storage device; and
program instructions to suspend the first operation based on:
the request, and
the power consumption.

16. The computer program product of claim 15, wherein the program instructions to detect the request comprise:
program instructions to receive the request from a host computing device associated with the storage device.

17. The computer program product of claim 15, wherein the program instructions comprise:
program instructions to initiate the second operation on the second die after suspending the first operation;
program instructions to complete the second operation on the second die; and
program instructions to resume the first operation on the first die after completing the second operation on the second die.

18. The computer program product of claim 15, wherein the first die and the second die are included on a storage medium of the storage device.

19. The computer program product of claim 15, wherein the program instructions comprise:
program instructions to determine that the power consumption of the storage device prevents the second operation from being performed with the first operation; and
program instructions to suspend the first operation based on:
detecting the request, and
determining that the power consumption of the storage device prevents the second operation from being performed with the first operation.

20. The computer program product of claim 15, wherein the first operation comprises a first read operation, a first write operation, or a first write operation, and
wherein the second operation comprises a second read operation, a second write operation, or a second write operation.
